(19) United States
(12) Patent Application Publication
(10) Pub. No.: US 2004/0007997 A1
(43) Pub. Date: Jan. 15, 2004

(54) Vector control system for permanent magnet sychronous machines using parameter scheduling table

(75) Inventor: Zhenxing Fu, Ann Arbor, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/194,159

(22) Filed: Jul. 11, 2002

(51) Int. Cl. H02P 7/00

(52) U.S. Cl. 318/432

(57) ABSTRACT

A method for achieving torque control of a permanent magnet synchronous motor is provided where operating conditions of the motor are sensed and used in a lookup table to retrieve corresponding reference values for calculating the electric current commands from a torque command. A lookup table for control of a permanent magnet synchronous motor is also provided. The lookup table comprises an input for at least one reference operating condition, with an output value of a retrieval operating condition for each value of the reference operating conditions. A method for lookup table control of a permanent magnet synchronous motor is also provided where an inductance differential and an uncompensated magnetic flux linkage are computed with a lookup table and limited. These values are then used to calculate an estimated inductance and a magnetic flux linkage.

### BACKGROUND OF THE INVENTION

Permanent magnet (PM) synchronous machines are often used in applications where system efficiency, system size, torque/volume ratio, and dynamic response time are of concern. These concerns are particularly strong for motors with low power ratings or with large mechanical air gaps. Typical applications of PM synchronous machines, also known as sinusoidal brushless DC motors (BLDC), in the automotive industry include electrical power assisted steering (EPAS) motors, integrated starter alternator (ISA) motors, and traction motors for hybrid electric vehicles (HEV) and electric vehicles (EV). PM synchronous machines typically require a power supply with sinusoidal waveforms for excitation. Such machines are typically controlled using vector control techniques, also known as field orientation controls, to achieve fast dynamic responses, high efficiencies, optimal peak transient power or torque capabilities, and wide ranges of operating speeds.

In automotive underhood applications, such as EPAS, ISA, HEV or EV, the typical ambient temperature during use of the vehicle ranges from about −40 C. to about 125 C. For ISA and HEV systems in particular, motor operating temperature may reach about 200 C., even with forced liquid cooling. The wide operating temperature range requirements adversely affect the performance of the ISA or HEV systems, as most vector control systems are achieved using closed-loop control of motor currents with open-loop torque controls. Torque control or speed control of the machine is achieved by converting the required or demanded torques into current commands using motor parameters, and the controls of torque are open-looped. Since the motor parameters heavily depend on the operating conditions of the machine, such as the operating temperature and the level of magnetic saturation, there is a considerable amount of error associated with the conversion of torque commands to current commands.

In PM synchronous machines used in ISA, HEV, and EPAS, for example, the calculation of current commands from the torque command requires the use of the flux linkage value produced by the magnets per phase, λ_{PM}^{e}, as well as the motor inductance along each of the direct and quadradure axes, L_{d} and L_{q}, as demonstrated below in EQ. 1:

$${i}_{qs}^{{e}^{*}} = \frac{{T}_{e}^{*}}{\frac{3 P}{4} [ {λ}_{PM}^{e} + ( {L}_{d} - {L}_{q} ) {i}_{ds}^{{e}^{*}} ]} \qquad ( EQ . 1 )$$

In the above equation, flux linkage produced by the magnet, λ_{PM}^{e}, strongly depends on the operating temperature and magnetic saturation level of the machine. Further, the motor inductances heavily depend on the level of magnetic saturation in the steel used in the machine. Hence, if the flux linkage and the motor inductances are not updated corresponding to the ever-changing operating conditions of the machine, significant errors will develop in the calculation of the current command, and thus in the torque control. The overall torque control error, as measured from the torque commanded as compared to the actual torque delivered by the motor, could exceed ±20%, as shown in the summary of torque control errors listed in Table 1.

TABLE 1
Estimated Torque Control Errors for Uncompensated Vector
Controlled PMSM Motor

| | Error | |
|---|---|---|
| Sources of Error | Percentage | Comments |
| PM Flux Linkage, λ^{e}_{PM}: | | |
| Br - Material | ±3% | Result of the tolerance of the |
| | | manufacturer's process |
| Br - Temperature | ±13% | −0.12%/C for −40° to 180° C. |
| Air gap | ±4% | ±0.3 mm variation on 1.0 mm |
| | | gap |
| Inductance, L_{q}: | ±5% | 20% variation due to q-axis |
| | | saturation |
| Inductance, L_{d}: | ±2% | 10% variation due to d-axis |
| | | saturation |
| Current sensors: | ±1% | Built-in error in Hall effect type |
| | | sensors |
| Total Error in Torque | ±28% | |

Such high torque control error adversely affects the overall system performance, degrades driver feel, and reduces consumer satisfaction. Since the main source of contribution to excessive torque control errors is the electrical parameters of the machine, such as λ_{PM}, and L_{q}, improvements in estimating those parameters corresponding to the actual operating conditions of the machine are necessary.

### BRIEF SUMMARY OF THE INVENTION

According to one aspect of the present invention, there is provided a method for providing current commands to a permanent magnet synchronous motor to achieve torque control. The operating temperature and the speed of the motor are sensed. A lookup table of magnetic flux values corresponding to the sensed conditions is provided. A value for the magnetic flux is retrieved from the lookup table based on the sensed operating temperature and motor speed. Current commands are then calculated as a function of the retrieved magnetic flux value.

According to another aspect of the present invention, there is provided a method for control of a permanent magnet synchronous motor. Operating conditions of the permanent magnet synchronous motor are sensed. Values are retrieved from at least one lookup table corresponding to the sensed operating conditions. Finally, a new torque command in a subsequent iteration is determined as a function of the retrieved values.

According to yet another aspect of the present invention, there is provided a lookup table apparatus for control of a permanent magnet synchronous motor comprising an input for at least one reference operating condition and a memory of a plurality of values of each of said reference operating conditions. It further comprises at least one retrieval operating condition and an output value of the retrieval operating condition for each value of the reference operating conditions.

According to still another aspect of the present invention, there is provided a method for lookup table control of a permanent magnet synchronous motor. An inductance differential is computed and limited. The inductance differential is then used to calculate an estimated inductance. An uncompensated magnetic flux linkage is also computed and limited. The uncompensated magnetic flux linkage is used to calculate a magnetic flux linkage.

Other aspects of the present invention will become apparent in connection with the following description of the present invention.

### BRIEF DESCRIPTION OF SEVERAL VIEWS OF THE DRAWINGS

FIG. 1A is a schematic diagram of a one-dimensional lookup table;

FIG. 1B is a schematic diagram of a two-dimensional lookup table;

FIG. 2 is a schematic diagram of a preferred embodiment of the lookup table of the present invention;

FIG. 3 is a schematic diagram of a preferred embodiment of the control method of present invention; and

FIG. 4 is a flow diagram of a preferred embodiment of the control method of the present invention.

### DETAILED DESCRIPTION OF THE INVENTION

The apparatus to perform the embodiment of the present invention comprises four general elements: the PM synchronous motor, a position sensor, a power electronics inverter, and a control apparatus. The power electronics inverter apparatus may comprise a plurality of power electronics switches and current sensors, a DC bus filter capacitor, a gate drive circuitry to control said power electronics switches, a cold plate to cool said power electronics switches, and a housing. The control apparatus may comprise a number of analog electronic components on a printed circuit board, a microprocessor or digital signal processor chip, and a number of digital electronic components.

Specific conventions have been used in the nomenclature of the variables throughout this application. For example, a variable followed by “*” denotes a command value; in other words, a value for the variable representing an input by the vehicle supervisory controller or another internal process. Also, a variable followed by “\hat{ }” denotes a value estimated by a lookup table. Further, the values set forth in this application are preferably vector values. As such, a variable followed by a subscript “d” denotes the vector value in the direct axis, the direction of the current flow. This coordinate of a vector value is responsible for production of the magnetic field and magnetic flux. A variable followed by a subscript “q” denotes the vector value in the quadradure, or perpendicular, axis. This coordinate of a vector value is responsible for the production of torque.

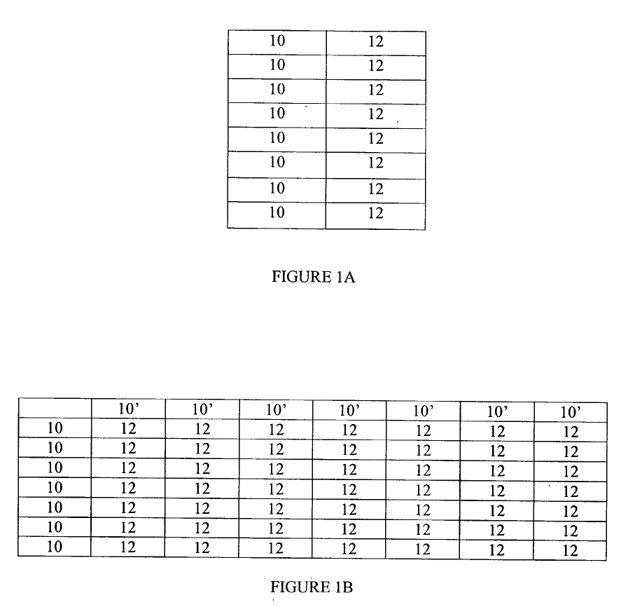

Examples of lookup tables are shown in FIGS. 1A and 1B. A lookup table comprises a plurality of reference values 10. The lookup table may have a single set of reference values 10, as in FIG. 1A, or may have multiple sets of reference values 10 and 10′, as in FIG. 1B. Each reference value 10, or combination of reference values 10 and 10′, are associated with an output value 12. The output value 12 associated with each reference value 10 is preferably determined prior to creating the lookup table by calculation or experimentation. By only requiring that a value be retrieved instead of calculated, a process can be sped up. In addition, the resolution, or difference between consecutive reference values, of a lookup table should preferably be as small as possible in order to promote high accuracy in the retrieved output values. For values in between the reference values (or set points), numerical interpolations will be used. The resolution, however, will be limited by the amount of memory space available to the lookup table.

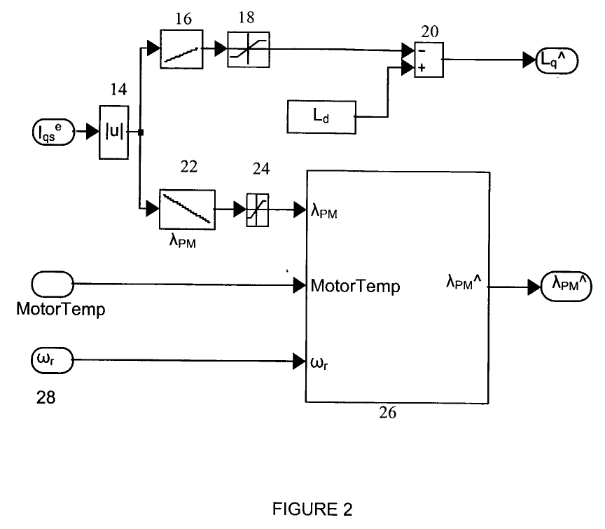

FIG. 2 is a schematic diagram of a preferred embodiment of the lookup table of the present invention. In a preferred embodiment, values for the inductance, L_{q}, and the magnetic flux linkage,

$${λ}_{PM}^{e} ,$$

are calculated from lookup tables based on operating condition values including motor temperature, are difficult to measure directly. However, values such as electrical currents, motor speed, and motor operating temperature are easy to measure, and each affects the value of the magnetic flux linkages or inductance. For example, a lookup table for magnetic flux linkage may contain values corresponding to combinations of the motor currents, the motor speed and the motor operating temperature.

In FIG. 2, an absolute value calculator 14, such as known in the art, receives the current along the q-axis, I_{q}, as input and outputs the absolute value of the current along the q-axis, ↑I_{q}|. The value of I_{q} input to the absolute value calculator 14 is computed based on the currents in the PM motor and the motor angular position. A vector rotation transformation is used, most commonly a Park transformation. From extensive numerical analysis of the magnetic field inside the machine and extensive test measurements, the magnetic flux linkage and motor inductances are predominantly affected by the current along the q-axis, I_{q}.

An inductance lookup table 16 takes as input the absolute value of the current along the q-axis, |I_{q}|, and retrieves a corresponding value for the difference between d axis and q axis inductances, (L_{d}−L_{q})\hat{ }, also known as the inductance differential. The inductance lookup table 16 is structured as discussed earlier. A limiter 18 then processes the inductance differential (L_{d}−L_{q})\hat{ } and clamps the difference within a predetermined range. A limiter 18, as is known in the art, acts as a check of the reasonability of the value input—if the input value is outside the expected range of values, the limiter 18 will output a value within the range. For example, if the expected value for a limiter was between 0.2 and 0.5, and 0.8 was input, the output would be 0.5, or the upper limit of the expected range. If 0.4 were input, however, the output would remain 0.4, as that value is within the expected range. The estimated motor inductance along q axis, L_{q}\hat{ }, is then determined by comparator 20. A comparator, as is known in the art, takes two inputs and outputs the difference between the two inputs. Here, comparator 20 takes L_{d} and the inductance differential, (L_{d}−L_{q})\hat{ }, as inputs and outputs their difference, or L_{q}\hat{ }.

Meanwhile, the magnetic flux linkage

$${λ}_{PM}^{e}$$

value is retrieved from magnetic flux lookup table 22. This value is a non-temperature compensated value, or one where the effects of temperature are not considered in determining the value. The magnetic flux lookup table 22 also takes the absolute value of the current along the q-axis, |I_{q}|, as an input, but this lookup table outputs values for the magnetic flux linkage

$${λ}_{PM}^{e} .$$

Once a value for the magnetic flux linkage

$${λ}_{PM}^{e}$$

has been retrieved from the magnetic flux lookup table 22, it is input to a limiter 24 to clamp the value within an expected range.

This value of

$${λ}_{PM}^{e}$$

is then fed into a compensation calculator 26 to determine

$${λ}_{PM}^{e} \hat{} ,$$

the estimated magnetic flux linkage value that takes motor temperature into consideration. The magnetic flux

$${λ}_{PM}^{e} ,$$

the motor speed, and the motor stator temperature are taken as inputs to the compensation calculator 26 to calculate the estimated flux linkage,

$${λ}_{PM}^{e} \hat{} .$$

The motor speed and the motor stator temperature is preferably measured via sensors. The motor speed sensor 28 is preferably located on the non-drive end of the rotor of the PM motor. The motor stator temperature sensor 30 is preferably located on the stator of the motor, near the stator end-turn windings. This placement allows for ease of manufacturing.

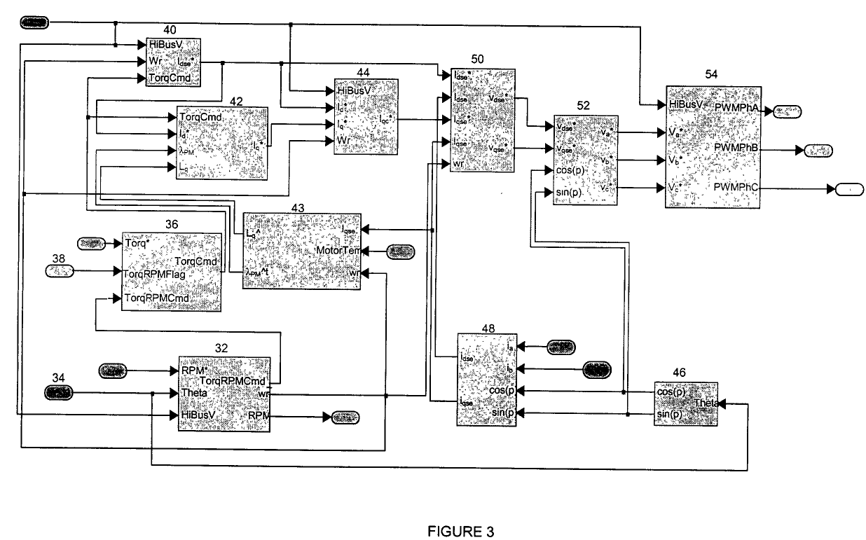

FIG. 3 is a schematic diagram showing an apparatus for implementing the preferred embodiment of the control method of the present invention.

In FIG. 3, speed regulator 32 calculates the mechanical speed of the motor in revolution per minute (RPM), electrical speed in radians per second, ωᵣ, and the torque required to achieve a speed command*. The speed command, RPM*, is defined as the speed requested by the vehicle operator or supervisory controller. The speed commands may be given by conventional methods, such as the position of a vehicle operator's foot on an accelerator, or may be the result of a set speed on a cruise control system, or determined by the supervisory controller during gear shifts. To calculate these values, the speed command, RPM*, the motor position, Θ, and the power electronics converter voltage, HBusV are used as inputs. The motor position, Θ, is preferably measured by a motor position sensor 34 located on the PM motor, more preferably located on the rotor shaft of the PM motor. The speed control of the speed regulator 32 is preferably obtained with the use of a conventional proportional-integral-derivative controller (“PID controller”), where the integrator is designed with anti-windup mechanisms to reduce error, as is known in the art. Preferably, these anti-windup mechanisms are provided to prevent integrators winding up after the saturation of the PID controller.

The required torque to achieve the speed command is then passed as an input to the mode selector 36. The mode selector 36 determines whether the apparatus is running in speed control mode or torque control mode, according to the position of a mode switch 38. The mode switch 38 is preferably a digital switch that can be controlled by the vehicle operator. The difference between the two modes is the controlled value. Speed control mode may be preferable during the gear shifts or engine cranking in case of HEV, whereas torque control mode would be more preferable for day-to-day driving and battery charging. The mode selector 36 outputs a torque command. This torque command represents the torque requested, if the mode switch 38 is in torque control mode, or torque required to achieved the desired speed, if the mode switch 38 is in speed control mode.

The flux current strategizer 40 is designed to calculate the magnetizing (d-axis) current, I_{ds}^{e}*. The flux current strategizer 40 takes as input motor electrical speed in rad/s, ωᵣ, the torque command, and the battery voltage. By using a “maximum torque per ampere” strategy for the entire operating speed range, including constant power operations, as is known in the art, I_{ds}^{e}* may be obtained.

The current decoupler 42 calculates the required q-axis current, I_{q}*, for the motor to deliver the required torque command, based on EQ. 1 above. The current decoupler 42 takes I_{ds}^{e}*, the torque command, and the values of

$${λ}_{PM}^{e} \hat{}$$

and L_{q}\hat{ } received from the parameter lookup table 43 as input. EQ. 1 is applied to obtain an output of the required q-axis current, I_{q}*. This calculated q-axis current command, I_{q}*, is clamped by limiter 44. The maximum current and voltage capabilities of the power electronics inverter driven motor system are used to determine the range in which I_{q}* will be clamped by the limiter 44. This check is necessary, as above, to prevent the system from exceeding the current and voltage limits and to ensure stable operation of the system.

Meanwhile, the motor position sensor 34 is used as input in a position converter 46 to compute the sine and cosine values of the rotor electrical position, sin(Θ) and cos(Θ). These sine and cosine values are used in a vector rotation translator 48 to transform motor currents from stationary reference coordinates to synchronous reference coordinates, and vice versa. Preferably, the vector rotation translator would use a Park transformation algorithm, as is known in the art. In the preferred embodiment of FIG. 3, the vector rotation translator 48 is a Park transformation. The vector rotation translator 48 calculates d-axis and q-axis currents in synchronous reference coordinates, I_{ds}^{e} and I_{qs}^{e} from the motor phase currents in stationary reference coordinates, iₐ and i_{b}, by using appropriate sine and cosine values of the rotor electrical position Θ.

The synchronous current regulator 50 calculates the voltages needed to regulate the d-axis and q-axis currents, I_{ds}^{e} and I_{qs}^{e}, according to the current commands, I_{ds}^{e}* and I_{qs}^{e}*. As part of this calculation, the synchronous current regulator 50 also calculates the d-axis and q-axis current regulation errors, ΔI_{d} and ΔI_{q}. They are internally used in the calculations of the synchronous current regulator 50 as inputs to conventional PID controllers that regulate the values of I_{ds}^{e} and I_{qs}^{e}. As earlier, anti-windup mechanisms are preferably provided in this PID controller. Additionally, to reduce the noise transmission through out the control system and to improve the dynamics, voltage feed forward compensations are preferably used. Voltage feed forward compensation reduces the effect of the coefficients used in the operation of a PID controller, and thereby reduces noise transmission. The required synchronous reference frame voltages needed to regulate d and q axis current commands are obtained by adding the outputs of PID controllers and voltage feed forward compensations. After applying proper voltage limits, the voltage commands in the synchronous reference coordinates, V_{ds}^{e}* and V_{qs}^{e}*, are determined.

A second vector rotation translator 52 is then used to translate the synchronous reference coordinates, the mathematical side of the present invention, back to stationary reference coordinates, representative of the physical side of the present invention. The current command vector, as defined by I_{ds}^{e}* and I_{q}*, is a purely mathematical construct—it has no specific representation in the physical world; instead, it merely decouples the effect of the motor phase currents according to their contributions to the magnetic flux and the torque. This representation of the current command vector yields quick and efficient control of the motor. However, the physical manifestation of a PM synchronous motor is a multi-phase system; preferably a three-phase system. The voltage needed in each of these phases, as per the current command, should preferably be calculated in order to actually, apply the current command vector to the physical PM motor.

In a preferred embodiment such as FIG. 3, the second vector rotation translator 52 is an inverse Park transformation. The second vector rotation translator 52 translates the voltage required in synchronous, mathematical reference coordinates to these needed in stationary, physical reference coordinates. The voltages required represented in stationary reference coordinates are referred to as vₐ*, V_{b}* and v_{c}* in FIG. 3.

The voltages, as expressed in stationary reference coordinates, represent the actual voltages to be applied to the motor via a power electronics inverter to regulate the current command, and thereby the torque command. Preferably, the waveform of the required voltages is sinusoidal, or AC current. The sinusoidal voltages required are realized preferably by providing sinusoidally pulse width modulated (“PWM”) signals to the gate drive circuitry of the power electronics inverter. The gate drive circuitry controls the power electronics inverter so as to produce sinusoidally PWM modulated voltages to the motor. A PWM signal generator 54 is designed to calculate the required PWM signals from the voltage required in stationary reference coordinates.

The PWM signal generator 54 uses a space vector modulation technique to synthesize sinusoidal voltage waveforms for minimizing voltage harmonics and improved use of effective inverter voltage. Such a space vector modulation technique is known in by those of skill in the art. Battery or DC voltage is accepted as an input of the PWM signal generator, and is adapted to the PWM signals. The individual PWM signals are sent to the gate drive circuitry to control the turn-on and turn-off of the inverter. Thereby, the power electronics inverter is able to supply controlled electric power with the proper magnitude and frequency to the PM motor, thus producing the commanded motor current and/or torque.

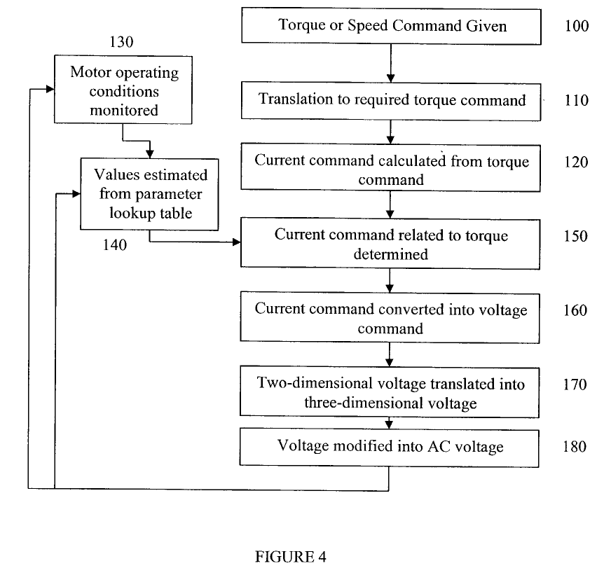

FIG. 4 is an overview flow diagram of one embodiment of the vector control process performed by the preferred embodiment of FIG. 3 or another embodiment of the present invention. First, a torque or speed command is given to the system and processed by the speed regulator 32 at Box 100. This torque or speed command may be one desired by the vehicle operator, or one required by a vehicular system such as the ISA or EPAS to maintain vehicle performance. The torque or speed command is then processed by the mode selector 36 at Box 110 to create a require torque command. The required torque command is the input to the flux current strategizer 40 at Box 120 to output a current command. Meanwhile, operating conditions of the motor, such as motor temperature, position, and speed, are monitored at Box 130, and fed to a parameter lookup table 43 at Box 140. The retrieved values are sent to the current decoupler 42, where the portion of the current command related to torque, I_{q}*, can be determined, at Box 150. The current regulator 50 converts the current command into voltage commands at Box 160. The voltage is transformed from a two-dimensional, synchronous vector representation to a three-phase, physical representation at the second vector rotator 52 at Box 170. The three phase representation of the voltage is modified by the PMW signal generator 54 into an AC voltage at Box 180 before being applied to the PM motor. The changes in motor operating conditions in applying the torque command to the PM motor are monitored back at Box 130 and Box 140, and the new conditions are input into a subsequent iteration.

TABLE 2 below gives the simulated torque control errors using this control strategy. Significant improvements on torque control accuracy are obtained.

TABLE 2
Estimated Torque Control Errors for Parameter Lookup Table Vector
Controlled PMSM Motor

| | Error | |
|---|---|---|
| Sources of Error | Percentage | Comments |
| PM Flux Linkage, λ^{e}_{PM}: | | |
| Br-Material | ±3% | Manufacturer's process |
| | | tolerance |
| Br-Temperature | ±2% | CFD model errors: speed, |
| | | airgap, insulation layers, etc |
| Air gap | ±4% | ±0.3 mm variation on 1.0 mm gap |
| Inductance, L_{q}: | ±1% | FEA modeling errors |
| Inductance, L_{d}: | ±0.5% | FEA modeling errors |
| Current sensors: | ±1% | Built-in error in Hall effect type |
| | | sensors |
| Quantification errors: | ±0.5% | Finite data entries in the look- |
| | | up table |
| Total Error in Torque | ±12% | |

As shown in TABLE 2, significant improvements on torque control accuracy may be obtained. The expected torque control errors for a vector control system using lookup tables can be reduced from about ±28% to less than about ±12%. That error may be further reduced if more memory is available for the construction of the lookup tables, as earlier discussed.

Although the invention herein has been described in connection with a preferred embodiment thereof, it will be appreciated by those skilled in the art that additions, modifications, substitutions, and deletions not specifically described may be made without departing from the spirit and scope of the invention as defined in the appended claims.

1. A method for providing current commands for the control of torque to a permanent magnet synchronous motor, said method comprising:
sensing the operating temperature of said motor;
sensing the motor speed of said motor;
providing a lookup table of magnetic flux values corresponding to said sensed operating temperature, and said sensed motor speed;
retrieving a value for said magnetic flux in said lookup table based on said sensed operating temperature, and said sensed motor speed; and
calculating a torque command as a function of said retrieved magnetic flux value.

2. The method of claim 1, further comprising:
sensing the electrical currents in said motor;
providing a lookup table of inductance values corresponding to said sensed electrical currents;
retrieving a value for said inductance in said lookup table based on said sensed electrical currents; and
calculating a torque command as a function of said retrieved inductance value.

3. A method for control of a permanent magnet synchronous motor comprising:
sensing operating conditions of said permanent magnet synchronous motor;
retrieving values from at least one lookup table corresponding to said sensed operating conditions; and
determining a new torque command in a subsequent iteration as a function of the retrieved values.

4. The method of claim 3, further comprising:
receiving a torque command; and
translating said torque command into a current command,
said steps before said step of sensing operating conditions.

5. The method of claim 3, wherein said operating conditions further comprise at least one member of the following group:
applied current;
permanent magnet synchronous motor speed; and
motor temperature.

6. The method of claim 5, wherein the operating conditions for motor temperature are measured using a temperature sensor.

7. A lookup table apparatus for control of a permanent magnet synchronous motor comprising:
an input for at least one reference operating condition;
a memory of a plurality of values of each of said reference operating conditions;
at least one retrieval operating condition; and
an output of a value of said retrieval operating condition for each of said values of said reference operating conditions.

8. The apparatus of claim 7, wherein said plurality of values of said reference operating conditions are evenly spaced from each other.

9. The apparatus of claim 8, wherein said reference operating conditions comprise permanent magnet synchronous motor speed and operating temperature.

10. The apparatus of claim 7, wherein said retrieval operating conditions comprise magnetic flux.

11. The apparatus of claim 8, wherein said reference operating conditions comprise applied current.

12. The apparatus of claim 11, wherein said retrieval operating conditions comprise inductance.

13. A method for lookup table control of a permanent magnet synchronous motor comprising:
computing an inductance differential;
limiting said inductance differential; and
calculating an estimated inductance from said inductance differential.

14. The method of claim 13, wherein said step of computing an inductance differential is performed by an inductance lookup table.

15. The method of claim 13, wherein said step of limiting said inductance differential is performed by a limiter.

16. The method of claim 13, wherein said step of calculating an estimated inductance is performed by a subtractor.

17. The method of claim 13, further comprising the steps of:
computing an uncompensated magnetic flux linkage;
limiting said uncompensated magnetic flux linkage; and
calculating an estimated magnetic flux linking from said uncompensated magnetic flux linkage.

18. The method of claim 17, wherein said step of computing an uncompensated magnetic flux linkage is performed by a magnetic flux linkage lookup table.

19. The method of claim 17, wherein said step of limiting said uncompensated magnetic flux linkage is performed by a limiter.

20. The method of claim 17, wherein said step of calculating an estimated magnetic flux linkage performed by a compensation calculator.
